(19) United States
(12) Patent Application Publication
(10) Pub. No.: US 2014/0155015 A1
(43) Pub. Date: Jun. 5, 2014

(54) Printed Circuit Board and Server Using the Same

(71) Applicants: INVENTEC (PUDONG) TECHNOLOGY CORPORATION, Shanghai (CN); INVENTEC CORPORATION, Taipei City (TW)

(72) Inventors: Hui-Yi WU, Shanghai (CN); Lian-Yin ZHU, Shanghai (CN); Xin-Guo JIN, Shanghai (CN)

(73) Assignees: INVENTEC CORPORATION, Taipei City (TW); Inventec (Pudong) Technology Corporation, Shanghai (CN)

(21) Appl. No.: 13/846,751

(22) Filed: Mar. 18, 2013

(30) Foreign Application Priority Data
Nov. 30, 2012 (CN) 201210505402.8

(51) Int. Cl. H04B 1/16

(52) U.S. Cl. CPC H04B 1/16
USPC 455/337

(57) ABSTRACT

A printed circuit board (PCB) includes multiple receiving components and a sending component. Each receiving component includes a receiving unit and a first control unit. The receiving unit receives a radio signal. The first control unit is configured with a first comparison table storing related information of the receiving component, and used for decoding the radio signal according to the first comparison table, to obtain a corresponding control signal. The sending component includes a sending unit and a second control unit. The sending unit sends the radio signals. The second control unit is configured with a second comparison table storing the related information of the receiving components. When the sending component outputs the control signals through the second control unit, the second control unit generates the control signals according to the second comparison table, and encodes the control signals to generate the radio signals.

### CROSS-REFERENCE TO RELATED APPLICATIONS

This non-provisional application claims priority under 35 U.S.C. §119(a) on Patent Application No(s). 201210505402.8 filed in China, P.R.C. on Nov. 30, 2012, the entire contents of which are hereby incorporated by reference.

### BACKGROUND OF THE DISCLOSURE

1. Technical Field of the Disclosure

The disclosure relates to a printed circuit board (PCB), and more particularly to a PCB capable of performing wireless transmission and a server using the same.

2. Description of the Related Art

In the manufacturing of a PCB, circuit layout is generally performed first to generate an electronic file of a layout chart. That is, a layout engineer places electronic components at predetermined positions on the PCB, connects the electronic components with wires to complete the design of the layout chart, and proceed to Gerber out according to the electronic file of the layout chart to generate a mask picture. Finally, the PCB manufacturer manufactures the PCB through the mask picture.

FIG. 1 is a block diagram of an ordinary PCB. To implement a signal transmission and related operations between the components, the layout engineer needs to perform wiring of components 110, 120, 130, 140 on the PCB 100 by using wires, so as to connect the components 110, 120, 130, 140. In the layout of the PCB 100, since the distances between the components 110, 120, 130, 140 are not the same, the layout engineer needs to set the wires of the same length between the components 110, 120, 130, 140, to achieve a time sequence synchronization of signals. Additionally, since diversified components are disposed on the PCB 100 and the space is limited, when the component 110 needs to be moved, the layout engineer needs to modify the length of the wires, which takes more time for modification.

The above layout manner may increase the design complexity of the layout, prolong the layout time, lower the layout efficiency, and waste the utilization space of the PCB. Therefore, the design of the PCB needs to be improved.

### SUMMARY OF THE DISCLOSURE

In an embodiment, the disclosure provides a printed circuit board (PCB) comprising a plurality of receiving components and a sending component. Each of the receiving components comprises a receiving unit and a first control unit. The receiving unit is configured for receiving a radio signal. The first control unit is coupled to the receiving unit and is configured with a first comparison table storing related information of the receiving component. The first control unit is configured for decoding the radio signal according to the first comparison table, so as to obtain a corresponding control signal. The sending component comprises a sending unit and a second control unit. The sending unit is configured for sending the radio signals. The second control unit is coupled to the sending unit and is configured with a second comparison table storing the related information of the receiving components. When the sending component outputs the control signals through the second control unit, the second control unit generates the control signals according to the related information of the receiving components, and encodes the control signals to generate the radio signals.

### BRIEF DESCRIPTION OF THE DRAWINGS

The disclosure will become more fully understood from the detailed description given herein below for illustration only, thus does not limit the disclosure, wherein:

FIG. 1 is a block diagram of an ordinary PCB;

FIG. 2A is a block diagram of a PCB of the disclosure;

FIG. 2B is another block diagram of a PCB of the disclosure;

FIG. 3A is a block diagram of a server of the disclosure; and

FIG. 3B is another block diagram of a server of the disclosure.

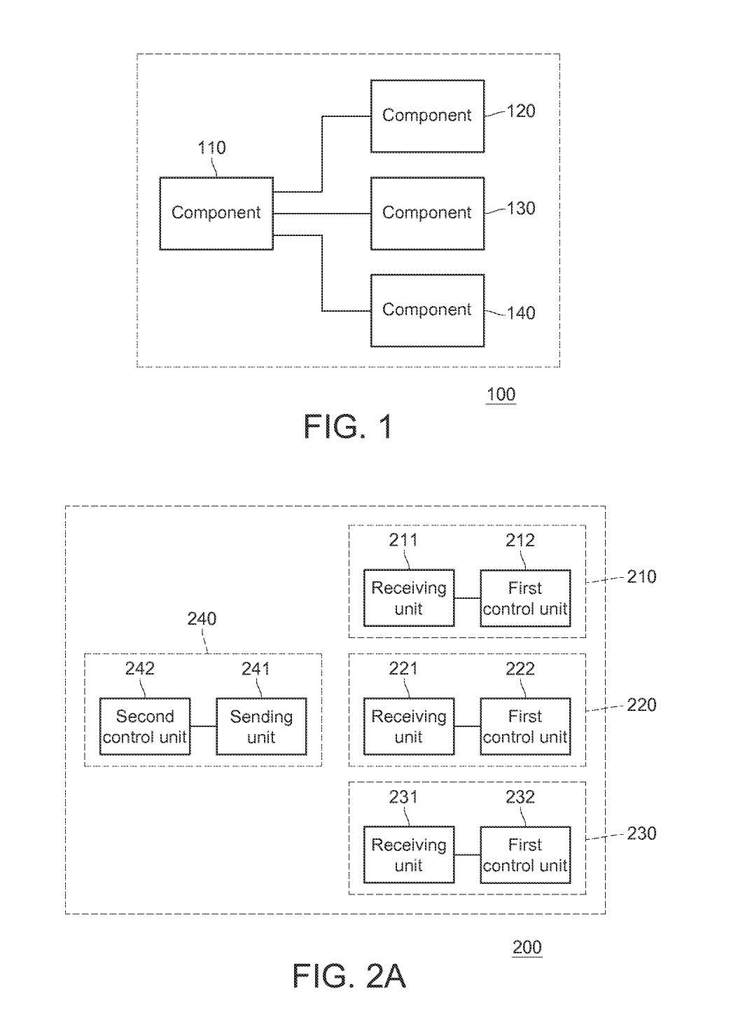

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the following embodiments, the same or similar components are marked by the same symbols.

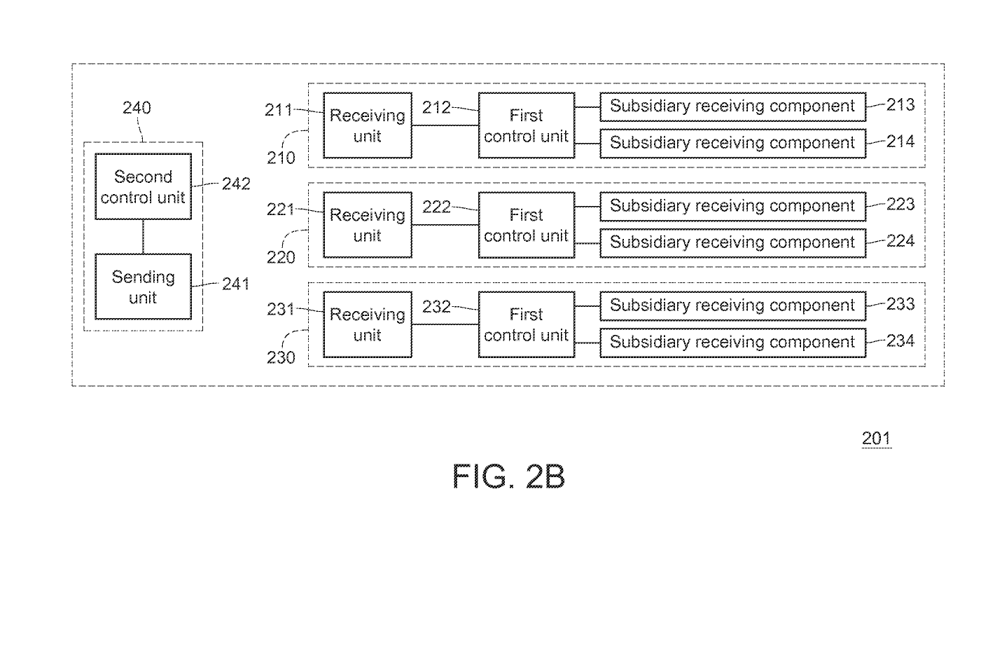

FIG. 2A is a block diagram of a PCB of the disclosure. The PCB 200 in this embodiment is a mainboard of a server. The PCB 200 comprises receiving components 210, 220, 230 and a sending component 240.

For ease of description, three receiving components (that is, the receiving components 210, 220, 230) are used in this embodiment as an example for illustration, but the disclosure is not limited thereto. Moreover, the user may adjust the number of the receiving components to be three or more upon requirements. The receiving components 210, 220, 230 are, for example, central processing units (CPUs), hard disks or other circuit components, such as resistors, inductors or capacitors.

The receiving components 210, 220, 230 respectively have receiving units 211, 221, 231 and first control units 212, 222, 232. The receiving units 211, 221, 231 are used for receiving radio signals.

The first control units 212, 222, 232 are coupled to the receiving units 211, 221, 231, and are respectively configured with a first comparison table, the first comparison tables respectively storing related information of the receiving components 210, 220, 230. The first control units 212, 222, 232 receive the radio signals, and decode the radio signals according to the related information of the receiving components 210, 220, 230 in the first comparison tables, to obtain corresponding control signals and proceed to perform related operations.

The sending component 240 comprises a sending unit 241 and a second control unit 242. The sending unit 241 is used for sending the radio signals. The second control unit 242 is coupled to the sending unit 241 and configured with a second comparison table storing the related information of the receiving components 210, 220, 230. When the sending component 240 is used for outputting the control signals through the second control unit 242, the second control unit 242 generates the corresponding control signals according to the related information of the receiving components 210, 220, 230. The second control unit 242 further encodes the control signals to generate the corresponding radio signals to be sent by the sending unit 241.

In this embodiment, the related information of the receiving components 210, 220, 230 comprises names and part numbers of the receiving components 210, 220, 230. The first comparison table of the first control unit 212 stores the name and the part number of the receiving component 210. The first comparison table of the first control unit 222 stores the name and the part number of the receiving component 220. The first comparison table of the first control unit 232 stores the name and the part number of the receiving component 230. The second comparison table of the second control unit 242 stores the names and the part numbers of the receiving components 210, 220, 230.

Since the second control unit 242 is capable of acquiring the corresponding part numbers and names of the receiving components 210, 220, 230 by looking up the second comparison table, the second control unit 242 generates the control signals, adds the names and the part numbers of the receiving components 210, 220, 230 into the corresponding control signals, and encodes the control signals into the radio signals to be sent by the sending unit 241 to the receiving components 210, 220, 230.

For example, assume that the name of the receiving component 210 is “resistor” and the part number thereof is “R1”, the name of the receiving component 220 is “inductor” and the part number thereof is “L2”, and the name of the receiving component 230 is “CPU” and the part number thereof is “CPU3”. The second control unit 242, for example, adds the serial number of “resistor_R1” into the control signal to be transmitted to the receiving component 210, the second control unit 242, for example, adds the serial number of “inductor_L2” into the control signal to be transmitted to the receiving component 220, and the second control unit 242, for example, adds the serial number of “CPU_CPU3” into the control signal to be transmitted to the receiving component 230.

When the receiving component 210 receives the radio signal having the serial number of “resistor_R1” through the receiving unit 211, the first control unit 212 decodes the radio signal having the serial number of “resistor_R1”, to obtain the control signal having the serial number of “resistor_R1”. The first control unit 212, subsequently is configured for confirming that the serial number of “resistor_R1” is consistent with the related information (that is, the name and the part number) of the receiving component 210 that is stored in the first comparison table, by looking up the first comparison table, so as to determine that the control signal is transmitted to the receiving component 210. Therefore, the receiving component 210 performs related operations according to the control signal.

When the receiving component 210 receives the radio signal having the serial number of “inductor_L2” through the receiving unit 211, the first control unit 212 decodes the radio signal having the serial number of “inductor_L2”, to obtain the control signal having the serial number of “inductor_L2”. The first control unit 212, subsequently, is configured for confirming that the serial number of “inductor_L2” is inconsistent with the related information (that is, the name and the part number) of the receiving component 210 that is stored in the first comparison table, by looking up the first comparison table, so as to determine that the control signal is not transmitted to the receiving component 210. Therefore, the receiving component 210 does not perform related operations.

When the receiving component 210 receives the radio signal having the serial number of “CPU_CPU3” through the receiving unit 211, the first control unit 212 decodes the radio signal having the serial number of “CPU_CPU3”, to obtain the control signal having the serial number of “CPU_CPU3”. Then, the first control unit 212 is configured for confirming that the serial number of “CPU_CPU3” is inconsistent with the related information (that is, the name and the part number) of the receiving component 210 that is stored in the first comparison table, by looking up the first comparison table, so as to determine that the control signal is not transmitted to the receiving component 210. Therefore, the receiving component 210 does not perform related operations.

Reference can be made to the implementation and description of the receiving component 210 for the related operations of the receiving components 220, 230, and the details are not repeated herein. The receiving components 210, 220, 230 respectively decode the received radio signals to obtain the control signals transmitted thereto, so as to perform related operations. Therefore, signal transmission errors can be avoided, and the wiring between the sending component 240 and the receiving components 210, 220, 230 is saved, so that the design and layout complexity of the PCB 200 is reduced.

In an embodiment, assume that the receiving components 220 and 230 are of the same type. For instance, the names of the receiving components 220 and 230 are “resistor” and the part numbers thereof are respectively “R1” and “R2”. The second control unit 242, for example, adds the serial numbers of “resistor_R1” and “resistor_R2” into the control signals to be transmitted to the receiving components 220 and 230, encodes the two control signals into two corresponding radio signals, and sets the radio signals into a group of radio signals to be sent by the sending unit 241. Therefore, the sending unit 241 is capable of sending the control signals to the receiving components 220 and 230 at the same time, to achieve time sequence control of time synchronization of the signals.

FIG. 2B is another block diagram of a PCB of the disclosure. The PCB 201 in this embodiment is different from the PCB 200 in FIG. 2A in that, in addition to the receiving units 211, 221, 231 and the first control units 212, 222, 232, the receiving components 210, 220, 230 of the PCB 201 further comprises subsidiary receiving components 213, 214, 223, 224, 233, 234.

The first control units 212, 222, 232 respectively store related information of the subsidiary receiving components 213, 214, 223, 224, 233, 234. The related information of the subsidiary receiving components 213, 214, 223, 224, 233, 234, for example, comprises names and part numbers of the subsidiary receiving components 213, 214, 223, 224, 233, 234.

The second comparison table of the second control unit 242 further stores the related information of the subsidiary receiving components 213, 214, 223, 224, 233, 234. When the sending component 240 is used for outputting the control signals through the second control unit 242, the second control unit 242 generates the control signals according to the related information of the receiving components 210, 220, 230 and the related information of the subsidiary receiving components 213, 214, 223, 224, 233, 234.

Then, the second control unit 242 further sets the control signals corresponding to the subsidiary receiving components 213, 214, 223, 224, 233, 234 of the receiving components 210, 220, 230 into a group of signals respectively, and encodes the groups of signals to generate the corresponding radio signals to be sent by the sending unit 241 to the first control units 212, 222, 232 of the receiving components 210, 220, 230.

The first control units 212, 222, 232 decode the radio signals having the groups of signals according to the related information of the subsidiary receiving components 213, 214, 223, 224, 233, 234, to obtain the control signals corresponding to the subsidiary receiving components 213, 214, 223, 224, 233, 234. Thereby, the subsidiary receiving components 213, 214, 223, 224, 233, 234 may perform related operations according to the corresponding control signals.

For example, assume that the name of the receiving component 210 is “functional component (FC)” and the part number thereof is “FC1”, the name of the subsidiary receiving component 213 is “resistor” and the part number thereof is “R2”, and the name of the subsidiary receiving component 214 is “baseboard management controller (BMC)” and the part number thereof is “BMC1”. The second control unit 242, for example, adds the serial numbers of “FC_FC1” and “resistor R2” as well as “FC_FC1” and “BMC_BMC1” into the control signals to be transmitted to the subsidiary receiving components 213, 214 of the receiving component 210 respectively.

The second control unit further sets the control signals to be transmitted to the subsidiary receiving components 213, 214 into a group of signals, and encodes the group of signals into the radio signals to be sent by the sending unit 241. The group of signals comprises the serial numbers of “FC_FC1” and “resistor_R2” as well as “FC_FC1” and “BMC_BMC1”.

When the receiving component 210 receives the radio signals having the serial numbers of “FC_FC1” and “resistor_R2” as well as “FC_FC1” and “BMC_BMC1” through the receiving unit 211, the first control unit 212 decodes the radio signals having the serial numbers of “FC_FC1” and “resistor_R2” as well as “FC_FC1” and “BMC_BMC1”, to obtain the control signals having the serial numbers of “FC_FC1” and “resistor_R2” as well as “FC_FC1” and “BMC_BMC1”.

The first control unit 212 is configured for confirming that the serial numbers of “FC_FC1” and “resistor_R2” as well as “FC_FC1” and “BMC_BMC1” are consistent with the related information (that is, the names and the part numbers) of the receiving component 210 and the subsidiary receiving components 213, 214 that is stored in the first comparison table, by looking up the first comparison table, so as to determine that the control signals are transmitted to the receiving component 210. The first control unit 212 transmits the corresponding “resistor_R2” and “BMC_BMC1” respectively to the subsidiary receiving components 213, 214, so that the subsidiary receiving components 213, 214 perform related operations accordingly.

When the first control unit 212 confirms, through comparison, that the decoded control signals are inconsistent with the related information (that is, the name and the part number) of the receiving component 210 that is stored in the first comparison table, it is determined that the control signals are not transmitted to the receiving component 210. Therefore, the receiving component 210 and the subsidiary receiving components 213, 214 do not perform related operations.

Reference can be made to the implementation and description of the receiving component 210 and the subsidiary receiving components 213, 214 for the related operations of the receiving components 220, 230 and the subsidiary receiving components 223, 224, 233, 234, and the details are not repeated herein. The receiving components 210, 220, 230 and the subsidiary receiving components 213, 214, 223, 224, 233, 234 respectively decode the received radio signals to obtain the control signals transmitted thereto, so as to perform related operations.

Therefore, signal transmission errors can be avoided, and the wiring between the sending component 240 and the receiving components 210, 220, 230 is saved, so that the design and layout complexity of the PCB 201 is reduced. Further, the control signals to be sent to the subsidiary receiving components of the same receiving component are set into a group of signals, so as to be sent to the receiving component at the same time. Therefore, the subsidiary receiving components are capable of receiving the control signals at the same time and performing related operations accordingly, to achieve time sequence control of time synchronization of the signals.

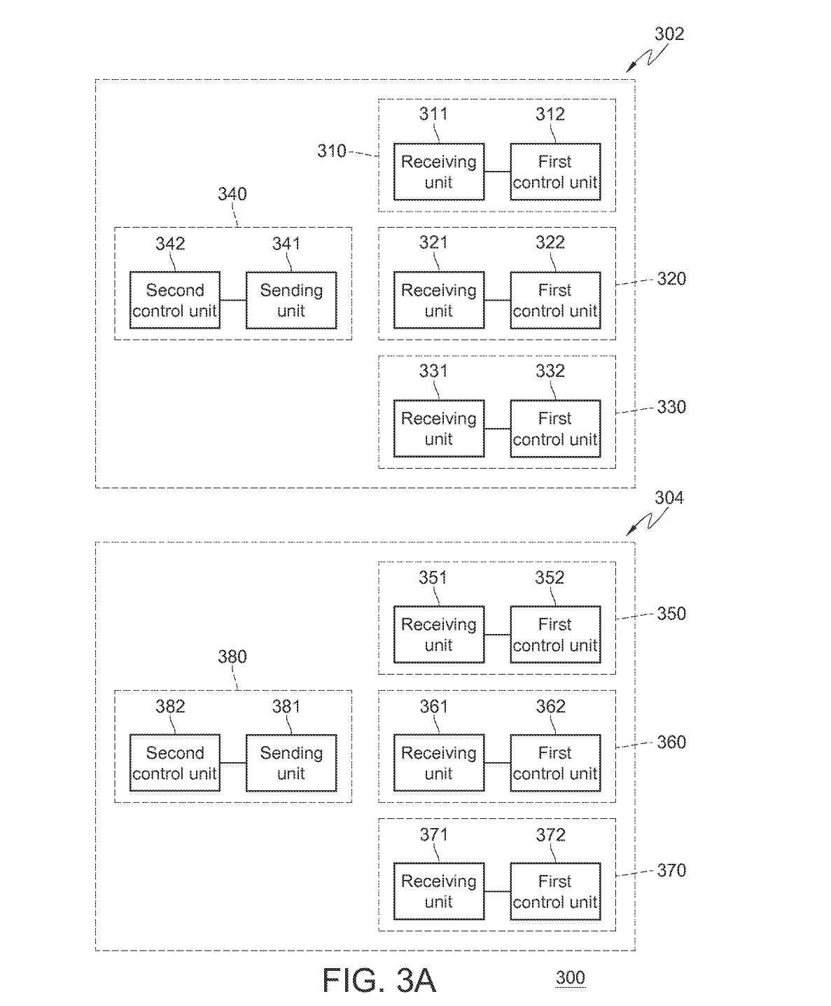

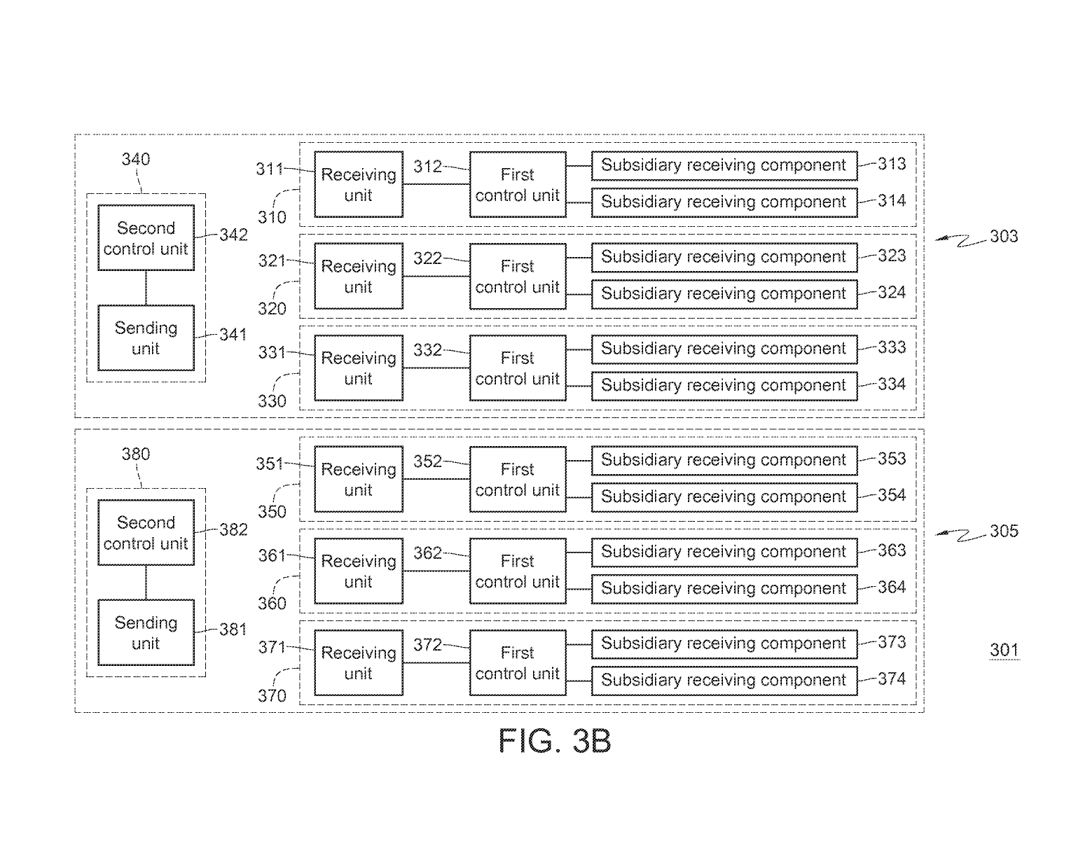

FIG. 3A is a block diagram of a server of the disclosure. The server 300 comprises PCBs 302 and 304. In this embodiment, the PCBs 302 and 304 in this embodiment are mainboards or riser cards of the server 300.

For ease of description, two PCBs (that is, the PCBs 302 and 304) are used in this embodiment as an example for illustration, but the disclosure is not limited thereto. Therefore, the user may adjust the number of the PCBs to be two or more upon requirements.

In this embodiment, the PCB 302 comprises receiving components 310, 320, 330 and a sending component 340. The receiving components 310, 320, 330 respectively comprise receiving units 311, 321, 331 and first control units 312, 322, 332. The sending component 340 comprises a sending unit 341 and a second control unit 342.

The PCB 304 comprises receiving components 350, 360, 370 and a sending component 380. The receiving components 350, 360, 370 respectively comprise receiving units 351, 361, 371 and first control units 352, 362, 372. The sending component 380 comprises a sending unit 381 and a second control unit 382. Reference can be made to the implementation of the PCB 200 in FIG. 2A for the internal components and implementation of the PCBs 302 and 304, and the details are not repeated herein.

The PCBs 302 and 304 in this embodiment are different from the PCB 200 in FIG. 2A in that, in addition to the related information of all the receiving components 310, 320, 330, 350, 360, 370, the second comparison tables in the second control units 342 and 382 of the PCBs 302 and 304 further store the related information of the PCBs 302 and 304.

Therefore, when the sending components 340, 380 are used for outputting the control signals through the second control units 342, 382, the second control units 342, 382 generate the corresponding control signals according to the related information of the receiving components 310, 320, 330, 350, 360, 370 and the related information of the PCBs 302, 304, and further encode the control signals to generate the corresponding radio signals to be sent by the sending units 341, 381.

In addition to the related information of the receiving components 310, 320, 330, 350, 360, 370, the first comparison tables in the first control units 312, 322, 332, 352, 362, 372 of the PCBs 302 and 304 further store the related information of the PCBs 302, 304. That is, the first comparison table in the first control unit 312 stores the related information of the receiving component 310 and the related information of the corresponding PCB 302. The implementation of the remaining first control units 322, 332, 352, 362, 372 can be deduced by analogy.

In this embodiment, the related information of the receiving components 310, 320, 330, 350, 360, 370 comprises the names and the part numbers of the receiving components 310, 320, 330, 350, 360, 370. The first comparison tables in the first control units 312, 322, 332, 352, 362, 372 of the receiving components 310, 320, 330, 350, 360, 370 respectively store the names and the part numbers of the receiving components 310, 320, 330, 350, 360, 370.

The related information of the PCBs 302 and 304, for example, comprises the names and the part numbers of the PCBs 302 and 304. The second comparison tables in the second control units 342 and 382 respectively store the names and the part numbers of the receiving components 310, 320, 330, 350, 360, 370 and the names and the part numbers of the PCBs 302 and 304.

The second control units 342 and 382 acquire, by looking up the second comparison tables, the corresponding part numbers and names of the receiving components 310, 320, 330, 350, 360, 370 and the PCBs 302, 304, so that the second control units 342 and 382 generate the control signals, add the names and the part numbers of the receiving components 310, 320, 330, 350, 360, 370 and the PCBs 302, 304 into the corresponding control signals, and encode the control signals into the radio signals to be sent by the sending units 341 and 381 to the receiving components 310, 320, 330, 350, 360, 370.

For example, assume that the name of the receiving component 310 is “resistor” and the part number thereof is “R1”, the name of the receiving component 320 is “inductor” and the part number thereof is “L2”, the name of the receiving component 330 is “CPU” and the part number thereof is “CPU3”, the name of the receiving component 350 is “resistor” and the part number thereof is “R2”, the name of the receiving component 360 is “inductor” and the part number thereof is “L4”, the name of the receiving component 370 is “capacitor” and the part number thereof is “C3”, the name of the PCB 302 is “PCB1” and the part number thereof is “001”, and the name of the PCB 304 is “PCB2” and the part number thereof is “003”.

The second control unit 342, for example, adds the serial numbers of “resistor_R1” and “PCB1_001” into the control signal to be transmitted to the receiving component 310, the second control unit 342, for example, adds the serial numbers of “inductor_L2” and “PCB1_001” into the control signal to be transmitted to the receiving component 320, the second control unit 342, for example, adds the serial numbers of “CPU_CPU3” and “PCB1_001” into the control signal to be transmitted to the receiving component 330, the second control unit 342, for example, adds the serial numbers of “resistor_R2” and “PCB2_003” into the control signal to be transmitted to the receiving component 350, the second control unit 342, for example, adds the serial numbers of “inductor_L4” and “PCB2_003” into the control signal to be transmitted to the receiving component 360, and the second control unit 342, for example, adds the serial numbers of “capacitor_C3” and “PCB2_003” into the control signal to be transmitted to the receiving component 370. The implementation of the second control unit 382 can be deduced by analogy, and the details are not repeated herein.

When the receiving component 310 receives the radio signal having the serial numbers of “resistor_R1” and “PCB1_001” through the receiving unit 311, the first control unit 312 decodes the radio signal having the serial numbers of “resistor_R1” and “PCB1_001”, to obtain the control signal having the serial numbers of “resistor_R1” and “PCB1_001”. Then, The first control unit 312 is configured for confirming that the serial numbers of “resistor_R1” and “PCB1_001” are consistent with the related information (that is, the name and the part number) of the receiving component 310 that is stored in the first comparison table, by looking up the first comparison table, so as to determine that the control signal is transmitted to the receiving component 310. Therefore, the receiving component 310 performs related operations according to the control signal.

When the receiving component 310 receives the radio signal having the serial numbers of “inductor_L2” and “PCB1_001” through the receiving unit 311, the first control unit 312 decodes the radio signal having the serial numbers of “inductor_L2” and “PCB1_001”, to obtain the control signal having the serial numbers of “inductor_L2” and “PCB1_001”. Then, the first control unit 312is configured for confirming that the serial numbers of “inductor_L2” and “PCB1_001” are inconsistent with the related information (that is, the name and the part number) of the receiving component 310 that is stored in the first comparison table, by looking up the first comparison table, so as to determine that the control signal is not transmitted to the receiving component 310. Therefore, the receiving component 310 does not perform related operations.

When the receiving component 310 receives the radio signal having the serial numbers of “CPU_CPU3” and “PCB1_001” through the receiving unit 311, the first control unit 212 decodes the radio signal having the serial numbers of “CPU_CPU3” and “PCB1_001”, to obtain the control signal having the serial numbers of “CPU_CPU3” and “PCB1_001”, and is configured for confirming that the serial numbers of “CPU_CPU3” and “PCB1_001” are inconsistent with the related information (that is, the name and the part number) of the receiving component 310 that is stored in the first comparison table, by looking up the first comparison table, so as to determine that the control signal is not transmitted to the receiving component 310. Therefore, the receiving component 310 does not perform related operations.

When the receiving component 310 receives the radio signal having the serial numbers of “resistor_R2” and “PCB2_003” through the receiving unit 311, the first control unit 212 decodes the radio signal having the serial numbers of “resistor_R2” and “PCB2_003”, to obtain the control signal having the serial numbers of “resistor_R2” and “PCB2_003”, and is configured for confirming that the serial numbers of “resistor_R2” and “PCB2_003” are inconsistent with the related information (that is, the name and the part number) of the receiving component 310 that is stored in the first comparison table, by looking up the first comparison table, so as to determine that the control signal is not transmitted to the receiving component 310. Therefore, the receiving component 310 does not perform related operations. The rest can be deduced by analogy.

Reference can be made to the implementation and description of the receiving component 310 for the related operations of the receiving components 320, 330, 350, 360, 370, and the details are not repeated herein. The receiving components 320, 330, 350, 360, 370 are configured for respectively decoding the received radio signals to obtain the control signals transmitted thereto, so as to perform related operations. Therefore, signal transmission errors can be avoided, and the wiring between the sending components 340, 380 and the receiving components 310, 320, 330, 350, 360, 370 is saved. Thereby, the design and layout complexity of the PCBs 302, 304 in the server 300 is reduced.

In an embodiment, assume that the receiving components 320 and 330 are of the same type. For example, the names of the receiving components 320 and 330 are “resistor” and the part numbers thereof are respectively “R1” and “R2”. The second control unit 342, for example, adds the serial numbers of “resistor_R1” and “resistor_R2” into the control signals to be transmitted to the receiving components 320 and 330, encodes the two control signals into two corresponding radio signals, and sets the radio signals into a group of radio signals to be sent by the sending unit 341. Therefore, the sending unit 341 is capable of sending the control signals to the receiving components 320 and 330 at the same time, to achieve time sequence control of time synchronization of the signals.

FIG. 3B is another block diagram of a server of the disclosure. The PCBs 303 and 305 of the server 301 in this embodiment are different from the PCBs 302, 304 in FIG. 3A in that, in addition to the receiving units 311, 321, 331, 351, 361, 371 and the first control units 312, 322, 332, 352, 362, 372, the receiving components 310, 320, 330, 350, 360, 370 of the PCBs 302, 304 further comprise subsidiary receiving components 313, 314, 323, 324, 333, 334, 353, 354, 363, 364, 373, 374.

The first control units 312, 322, 332, 352, 362, 372 respectively store related information of the subsidiary receiving components 313, 314, 323, 324, 333, 334, 353, 354, 363, 364, 373, 374. The related information of the subsidiary receiving components 313, 314, 323, 324, 333, 334, 353, 354, 363, 364, 373, 374, for example, comprises names and part numbers of the subsidiary receiving components 313, 314, 323, 324, 333, 334, 353, 354, 363, 364, 373, 374.

The second comparison tables in the second control units 342 and 382 further store the related information of the subsidiary receiving components 313, 314, 323, 324, 333, 334, 353, 354, 363, 364, 373, 374. When the sending components 340 and 380 are used for outputting the control signals through the second control units 342 and 382, the second control units 342 and 382 generate the control signals according to the related information of the receiving components 310, 320, 330, 350, 360, 370 and the related information of the subsidiary receiving components 313, 314, 323, 324, 333, 334, 353, 354, 363, 364, 373, 374.

The second control units 342 and 382 further set the control signals corresponding to the subsidiary receiving components 313, 314, 323, 324, 333, 334, 353, 354, 363, 364, 373, 374 of the receiving components 310, 320, 330, 350, 360, 370 into a group of signals respectively, and encode the groups of signals to generate the corresponding radio signals to be sent by the sending units 341 and 381 to the first control units 311, 321, 331, 351, 361, 371 of the receiving components 310, 320, 330, 350, 360, 370.

Then, the first control units 311, 321, 331, 351, 361, 371 decode the radio signals having the groups of signals according to the related information of the subsidiary receiving components 313, 314, 323, 324, 333, 334, 353, 354, 363, 364, 373, 374, to obtain the control signals corresponding to the subsidiary receiving components 313, 314, 323, 324, 333, 334, 353, 354, 363, 364, 373, 374. Thereby, the subsidiary receiving components 313, 314, 323, 324, 333, 334, 353, 354, 363, 364, 373, 374 may perform related operations according to the corresponding control signals.

Reference can be made to the implementation of the PCB 201 in FIG. 2B for the implementation of the PCBs 302, 304, and the details are not repeated herein. Therefore, this embodiment is able to reduce the design and layout complexity of the PCBs 302, 304, to achieve time sequence control of time sequence synchronization of the signals.

According to the PCB and the server using the same provided by the embodiments of the disclosure, the sending component is configured with the sending unit and the receiving components are configured with the receiving units, and the second control unit generates the control signals to be output to the receiving components according to the related information of the receiving components, encodes the control signals to generate the radio signals, and transmits the radio signals to the receiving units in a wireless manner. The receiving units decode the radio signals, and the first control units of the receiving units obtain the corresponding control signals according to the related information of the receiving components, so as to perform related operations.

In addition to the related information of the receiving components, the second control unit may also generate the corresponding control signals according to the related information of the PCBs. Thereby, false actions of the receiving components on different PCBs can be prevented. When the receiving components are of the same type, the second control unit encodes the control signals into the radio signals, and sets the radio signals into a group of radio signals to be sent by the sending unit. Furthermore, the control signals to be sent to the subsidiary receiving components of the same receiving component are set into a group of signals, so that the subsidiary receiving components are capable of receiving the control signals at the same time and performing related operations accordingly. Therefore, the design complexity of the layout is effectively reduced, the layout efficiency and utilization space of the PCB are improved, and time sequence control of time synchronization of the signals is achieved.

What is claimed is:

1. A printed circuit board (PCB), comprising:
a plurality of receiving components, each comprising:
a receiving unit configured for receiving a radio signal; and
a first control unit coupled to the receiving unit and configured with a first comparison table storing related information of the receiving component, the first control unit being configured for decoding the radio signal according to the first comparison table, so as to obtain a corresponding control signal; and
a sending component, comprising:
a sending unit configured for sending the radio signals; and
a second control unit coupled to the sending unit and configured with a second comparison table storing the related information of the receiving components, wherein when the sending component outputs the control signals through the second control unit, the second control unit generates the control signals according to the related information of the receiving components, and encodes the control signals to generate the radio signals.

2. The PCB according to claim 1, wherein the related information of the receiving components comprises names and part numbers of the receiving components.

3. The PCB according to claim 1, wherein if a part of the receiving components are of the same type, when the sending component outputs the control signals corresponding to the part of the receiving components through the second control unit, the second control unit encodes the control signals corresponding to the part of the receiving components into a part of the radio signals, and sets the part of the radio signals into a group of radio signals to be sent by the sending unit.

4. The PCB according to claim 1, wherein each receiving component comprises a plurality of subsidiary receiving components, the subsidiary receiving components are coupled to the corresponding first control unit, the first comparison table further stores related information of the subsidiary receiving components, and the second comparison table further stores the related information of the subsidiary receiving components of the receiving components; when the sending component outputs the control signals through the second control unit, the second control unit generates the control signals according to the related information of the receiving components and the related information of the subsidiary receiving components, sets the control signals corresponding to the subsidiary receiving components of each receiving component into a group of signals, and encodes the groups of signals into the radio signals to be sent by the sending unit to the first control units; and the first control units decode the radio signals having the groups of signals according to the related information of the subsidiary receiving components, to obtain the control signal corresponding to each subsidiary receiving component.

5. A server, comprising:
a plurality of printed circuit boards (PCBs), each comprising:
a plurality of receiving components, each comprising:
a receiving unit configured for receiving a radio signal; and
a first control unit coupled to the receiving unit and configured with a first comparison table storing related information of the receiving component and related information of the corresponding PCB, the first control unit being configured for decoding the radio signal according to the first comparison table, so as to obtain a corresponding control signal; and
a sending component, comprising:
a sending unit configured for sending the radio signals; and
a second control unit coupled to the sending unit and configured with a second comparison table storing the related information of the receiving components and the related information of the PCBs, wherein when the sending component outputs the control signals through the second control unit, the second control unit generates the control signals according to the related information of the receiving components and the related information of the PCBs, and encodes the control signals to generate the radio signals.

6. The server according to claim 5, wherein the related information of the receiving components comprises names and part numbers of the receiving components.

7. The server according to claim 5, wherein the related information of the PCBs comprises names and part numbers of the PCBs.

8. The server according to claim 5, wherein when a part of the receiving components are of the same type and when the sending component outputs the control signals corresponding to the part of the receiving components through the second control unit, the second control unit encodes the control signals corresponding to the part of the receiving components into a part of the radio signals, and sets the part of the radio signals into a group of radio signals to be sent by the sending unit.

9. The server according to claim 5, wherein each receiving component comprises a plurality of subsidiary receiving components, the subsidiary receiving components are coupled to the corresponding first control unit, the first comparison table further stores related information of the subsidiary receiving components, and the second comparison table further stores the related information of the subsidiary receiving components of the receiving components, when the sending component outputs the control signals through the second control unit, the second control unit generates the control signals according to the related information of the PCBs, the related information of the receiving components and the related information of the subsidiary receiving components, sets the control signals corresponding to the subsidiary receiving components of the receiving components of each PCB into a group of signals, and encodes the groups of signals into the radio signals to be sent by the sending unit to the first control units, and the first control units decode the radio signals having the groups of signals according to the related information of the subsidiary receiving components, to obtain the control signal corresponding to each subsidiary receiving component.
